(19) United States
(12) Patent Application Publication
(10) Pub. No.: US 2023/0314716 A1
(43) Pub. Date: Oct. 5, 2023

(54) EMISSION OF PARTICULAR WAVELENGTH BANDS UTILIZING DIRECTED WAVELENGTH EMISSION COMPONENTS IN A DISPLAY SYSTEM

(71) Applicant: Meta Platforms Technologies, LLC, Menlo Park, CA (US)

(72) Inventors: Dominic MEISER, Bothell, WA (US); Yang YANG, Redmond, WA (US); Wanli CHI, Sammamish, WA (US); Wai Sze Tiffany LAM, Lynnwood, WA (US)

(73) Assignee: Meta Platforms Technologies, LLC, Menlo Park, CA (US)

(21) Appl. No.: 17/707,552

(22) Filed: Mar. 29, 2022

(51) Int. Cl. G02B 6/293; G02B 27/01; G06F 1/16

(52) U.S. Cl. CPC G02B 6/29316; G02B 27/0172; G02B 2027/0178; G02B 2027/0123; G02B 2027/0132; G06F 1/163

(57) ABSTRACT

According to examples, a system for particular emission of wavelength bands using one or more directed wavelength emission components is described. The system may include a wearable eyewear arrangement having a lens assembly. The lens assembly may include a projector to project display light associated with an image and a waveguide for propagating the display light to enable viewing of the image by a user. The projector may include an illumination source component to generate the display light and a directed wavelength emission component coupled to the illumination source component to filter the display light according to one or more filtering characteristics.

### TECHNICAL FIELD

This patent application relates generally to a display system with enhanced image quality and increased energy efficiency, and more specifically, to systems and methods for particular emission of wavelength bands using one or more directed wavelength emission components.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms wearable display systems. One such example may be a head-mounted device (HMD), such as wearable eyewear, wearable headset, or eyeglasses. In some examples, a head-mounted device (HMD) may employ a first projector and a second projector to propagate a first image and a second image, respectively, to generate a displayed image for viewing by a user.

In some instances, to generate a displayed image for the user, a projector in a display system may implement a broadband light source, wherein a portion (or a majority) of light projected by the broadband light source may be unused. In these instances, the unused light may lead to unnecessary energy consumption and unwanted artifacts in a displayed image.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIG. 3 is a perspective view of a near-eye display in the form of a pair of glasses, according to an example.

FIG. 4 illustrates a schematic diagram of an optical system in a near-eye display system, according to an example.

FIG. 5 illustrates a diagram of a waveguide, according to an example.

FIG. 6 illustrates a diagram of a waveguide including an arrangement of volume Bragg gratings (VBGs), according to an example

FIGS. 7A-7B illustrate diagrams of waveguide configurations including an arrangement of volume Bragg gratings (VBGs), according to examples.

FIG. 8 illustrates a diagram of a back-mounted arrangement for a display system in a shape of eyeglasses, according to an example.

FIG. 9 illustrates a representation of various diffractions associated with on arrangement of gratings for one fixed wavelength, according to an example.

FIG. 10 illustrates a diagram depicting light traveling through a waveguide configuration, according to an example.

FIGS. 11A-11B illustrate a diagram of a first display system, according to an example.

FIG. 12 illustrates a diagram of a second display system, according to an example.

FIGS. 13A-13C illustrate multiple diagrams associated with a projector that may be included in a display system, according to an example.

FIG. 14 illustrates a diagram of an illumination source component and a directed wavelength emission component, according to an example.

FIGS. 15A-15B illustrate multiple diagrams of an illumination source component, according to examples.

FIG. 16 illustrates a method for selective emission of wavelength bands in a display system utilizing a directed wavelength emission component, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

The systems and methods described herein may provide a display system (e.g., AR-based head-mounted device (HMD) or eyewear) including at least one directed wavelength emission component for directing light projected from at least one projector, e.g., via one or more optical components, of the display system to provide increased energy efficiency and image clarity. In some examples, and as discussed further below, a “directed wavelength emission component”, as described herein, may be a component associated with the device system to emit, modify, or adjust projected or propagated light coming from a projector or one or more optical components. In some examples and as discussed further below, the directed wavelength emission component may provide emission of display light in a “directed” manner by filtering display light projected by a projector. In other examples and as also discussed further below, the directed wavelength emission component may provide emission of display light in a “directed” manner by selectively emitting display light by a projector as well.

In some examples, a directed wavelength emission component of display system may be implemented to limit or eliminate unused light projected from a projector. As used herein, “unused” light may include any light that may be propagated to and/or within a waveguide configuration but not be propagated from or out of a waveguide configuration for viewing purposes by a user or wearer of the head-mounted device (HMD). In particular, in many instances and as discussed further below, a projector utilizing a broadband light source may be implemented to project excessive (i.e., unused) light, thereby causing unnecessary energy consumption. In some examples as described herein, a display system including a directed wavelength emission component as described may enable greater energy efficiency by filtering (only) for or selectively emitting a particular (i.e., select) wavelength spectrum that may be associated with a displayed image for viewing by a user.

Also, in many instances, excessive light projected by a projector may reduce image quality or exhibit other characteristics that inhibit proper viewing by a user. In particular, in some instances, excessive light may produce unwanted additions to a displayed image (e.g., artifacts, haze, ghost images due to crosstalk, etc.). In some examples, and as also discussed further below, the directed wavelength emission component may enhance image quality by filtering (out) or selectively not emitting unnecessary portions of a wavelength spectrum and projecting a particular (i.e., select) wavelength spectrum that may be associated with a displayed image for viewing by a user.

The systems and methods described herein may be associated with a volume Bragg grating (VBG)-based waveguide display device. As used herein, a volume Bragg grating (VBG) may refer to a substantially and/or completely transparent optical device or component that may exhibit a periodic variation of refractive index (e.g., using a volume Bragg grating (VBG)). As discussed further in the examples below, an arrangement of one or more volume Bragg gratings (VBGs) may be provided with or integrated within a waveguide configuration of a display system. As used herein, a waveguide (or “waveguide configuration”) may refer to any optical structure that propagates a variety of signals (e.g., optical signals, electromagnetic waves, sound waves, etc.) in one or more directions. Employing principles of physics, information contained in such signals, may be directed using any number of waveguides or similar components.

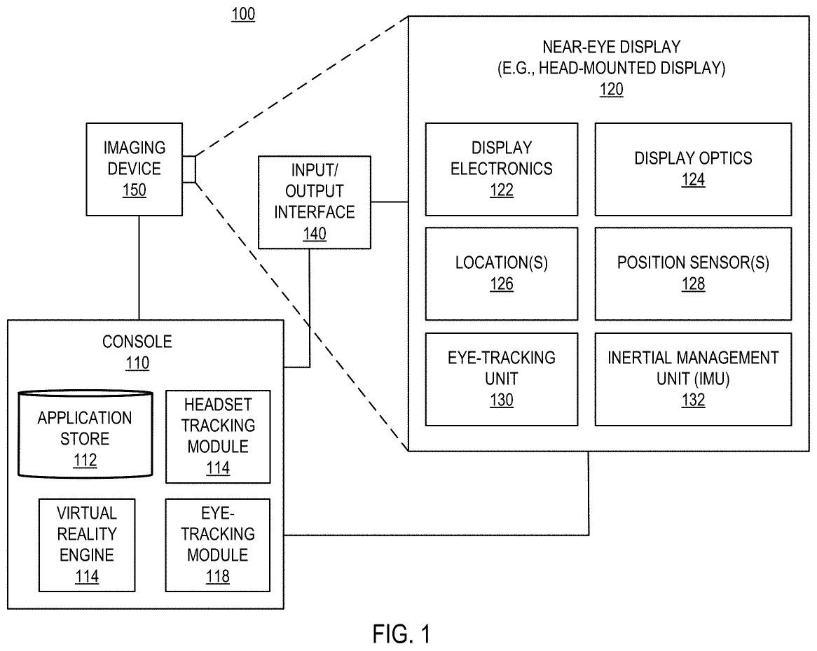

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

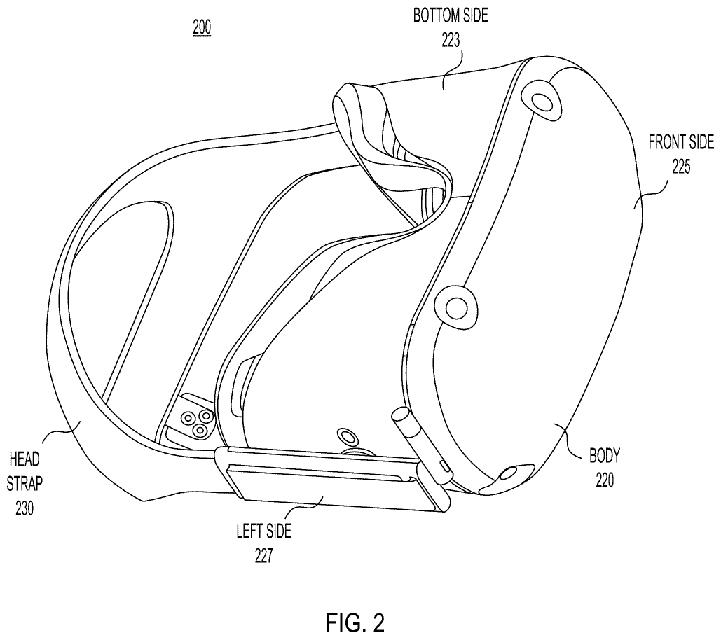

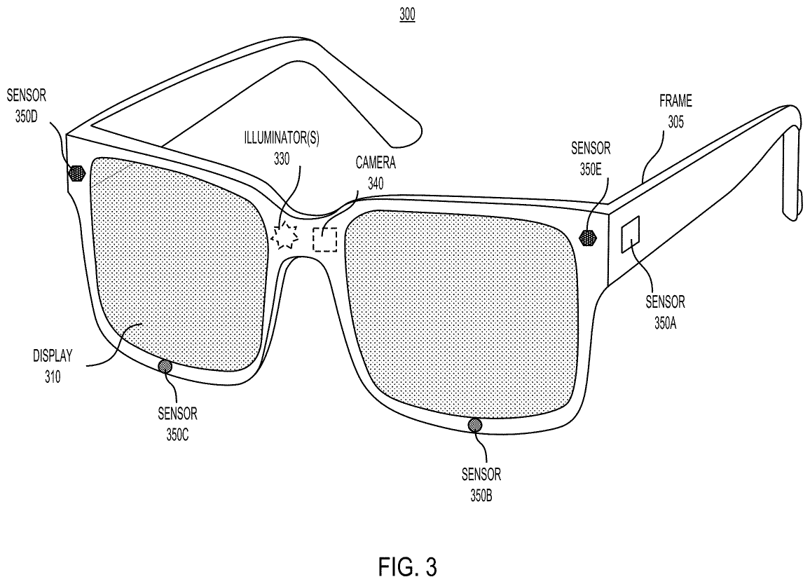

In some examples, the near-eye display 120 may be implemented in any suitable form-factor, including a HMD, a pair of glasses, or other similar wearable eyewear or device. Examples of the near-eye display 120 are further described below with respect to FIGS. 2 and 3. Additionally, in some examples, the functionality described herein may be used in a HMD or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near-eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye-tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the HMD device 200 may be a part of a virtual reality (VR) system, an augmented reality (AR) system, a mixed reality (MR) system, another system that uses displays or wearables, or any combination thereof. In some examples, the HMD device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the HMD device 200 for allowing a user to mount the HMD device 200 onto the user's head. In some examples, the HMD device 200 may include additional, fewer, and/or different components.

In some examples, the HMD device 200 may present, to a user, media or other digital content including virtual and/or augmented views of a physical, real-world environment with computer-generated elements. Examples of the media or digital content presented by the HMD device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the HMD device 200.

In some examples, the HMD device 200 may include various sensors (not shown), such as depth sensors, motion sensors, position sensors, and/or eye tracking sensors. Some of these sensors may use any number of structured or unstructured light patterns for sensing purposes. In some examples, the HMD device 200 may include an input/output interface 140 for communicating with a console 110, as described with respect to FIG. 1. In some examples, the HMD device 200 may include a virtual reality engine (not shown), but similar to the virtual reality engine 116 described with respect to FIG. 1, that may execute applications within the HMD device 200 and receive depth information, position information, acceleration information, velocity information, predicted future positions, or any combination thereof of the HMD device 200 from the various sensors.

In some examples, the information received by the virtual reality engine 116 may be used for producing a signal (e.g., display instructions) to the one or more display assemblies. In some examples, the HMD device 200 may include locators (not shown), but similar to the virtual locators 126 described in FIG. 1, which may be located in fixed positions on the body 220 of the HMD device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific implementation of near-eye display 120 of FIG. 1, and may be configured to operate as a virtual reality display, an augmented reality display, and/or a mixed reality display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display 300, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminators 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

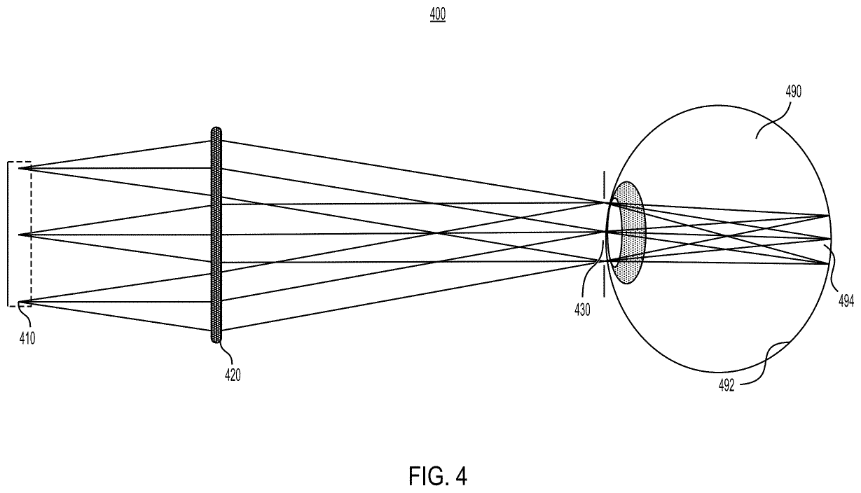

FIG. 4 illustrates a schematic diagram of an optical system 400 in a near-eye display system, according to an example. In some examples, the optical system 400 may include an image source 410 and any number of projector optics 420 (which may include waveguides having gratings as discussed herein). In the example shown in FIG. 4, the image source 410 may be positioned in front of the projector optics 420 and may project light toward the projector optics 420. In some examples, the image source 410 may be located outside of the field of view (FOV) of a user's eye 490. In this case, the projector optics 420 may include one or more reflectors, refractors, or directional couplers that may deflect light from the image source 410 that is outside of the field of view (FOV) of the user's eye 490 to make the image source 410 appear to be in front of the user's eye 490. Light from an area (e.g., a pixel or a light emitting device) on the image source 410 may be collimated and directed to an exit pupil 430 by the projector optics 420. Thus, objects at different spatial locations on the image source 410 may appear to be objects far away from the user's eye 490 in different viewing angles (i.e., fields of view (FOV)). The collimated light from different viewing angles may then be focused by the lens of the user's eye 490 onto different locations on retina 492 of the user's eye 490. For example, at least some portions of the light may be focused on a fovea 494 on the retina 492. Collimated light rays from an area on the image source 410 and incident on the user's eye 490 from a same direction may be focused onto a same location on the retina 492. As such, a single image of the image source 410 may be formed on the retina 492.

In some instances, a user experience of using an artificial reality system may depend on several characteristics of the optical system, including field of view (FOV), image quality (e.g., angular resolution), size of the eyebox (to accommodate for eye and head movements), and brightness of the light (or contrast) within the eyebox. Also, in some examples, to create a fully immersive visual environment, a large field of view (FOV) may be desirable because a large field of view (FOV) (e.g., greater than about 60°) may provide a sense of “being in” an image, rather than merely viewing the image. In some instances, smaller fields of view may also preclude some important visual information. For example, a head-mounted display (HMD) system with a small field of view (FOV) may use a gesture interface, but users may not readily see their hands in the small field of view (FOV) to be sure that they are using the correct motions or movements. On the other hand, wider fields of view may require larger displays or optical systems, which may influence the size, weight, cost, and/or comfort of the head-mounted display (HMD) itself.

In some examples, a waveguide may be utilized to couple light into and/or out of a display system. In particular, in some examples and as described further below, light of projected images may be coupled into or out of the waveguide using any number of reflective or diffractive optical elements, such as gratings. For example, as described further below, one or more volume Bragg gratings (VBGs) may be utilized in a waveguide-based, back-mounted display system (e.g., a pair of glasses or similar eyewear).

In some examples, one or more volume Bragg gratings (VBGs) (or two portions of a same grating) may be used to diffract display light from a projector to a user's eye. Furthermore, in some examples, the one or more volume Bragg gratings (VBGs) may also help compensate for any dispersion of display light caused by each other to reduce the overall dispersion in a waveguide-based display system.

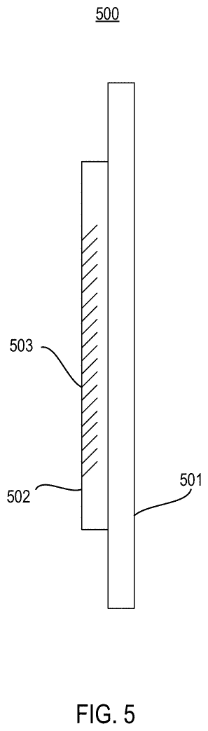

FIG. 5 illustrates a diagram of a waveguide configuration 500, according to an example. In some examples, the waveguide configuration 500 may include a plurality of layers, such as at least one substrate 501 and at least one photopolymer layer 502. In some examples, the substrate 501 may be a comprised of a polymer or glass material. In some examples, the photopolymer layer 502 may be transparent or “see-through”, and may include any number of photosensitive materials (e.g., a photo-thermo-refractive glass) or other similar material.

In some examples, at least one substrate 501 and at least one photopolymer layer 502 may be optically bonded (e.g., glued on top of each other) to form the waveguide configuration 500. In some examples, the substrate 501 may have a thickness of anywhere between around 0.1-1.0 millimeters (mm) or other thickness range. In some examples, the photopolymer layer 502 may be a film layer having a thickness of anywhere between about 50-500 micrometers (μm) or other range.

In some examples, one or more volume Bragg gratings (VBGs) may be provided in (or exposed into) the photopolymer layer 502. That is, in some examples, one or more (e.g., from ten to hundreds) volume Bragg gratings may be exposed by generating an interference pattern 503 into the photopolymer layer 502. In some examples, the interference pattern 503 may be generated by superimposing two lasers to create a spatial modulation (i.e., an alteration of an existing refractive index) that may generate the interference pattern 503 in and/or throughout the photopolymer layer 502. In some examples, the interference pattern 503 may be a sinusoidal pattern. Also, in some examples, the interference pattern 503 may be made permanent via a chemical, optical, mechanical, or other similar process.

By exposing the interference pattern 503 into the photopolymer layer 502, for example, the refractive index of the photopolymer layer 502 may be altered and a volume Bragg grating may be provided in the photopolymer layer 502. Indeed, in some examples, a plurality of volume Bragg gratings or one or more sets of volume Bragg gratings may be exposed in the photopolymer layer 502. It should be appreciated that this technique may be referred to as “multiplexing.” It should also be appreciated that other various techniques to provide a volume Bragg grating (VBG) in the photopolymer layer 502 may also be provided.

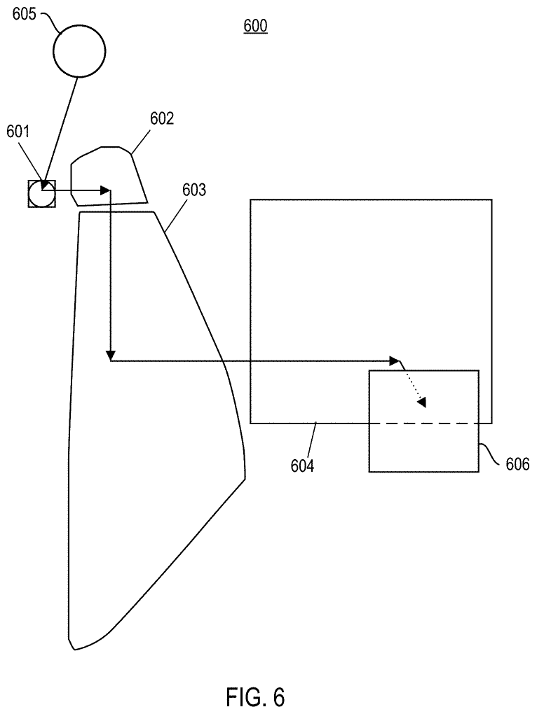

FIG. 6 illustrates a diagram of a waveguide configuration 600 including an arrangement of volume Bragg gratings (VBGs), according to an example. In some examples, the waveguide configuration 600 may be used a display system, similar to the near-eye display system 300 of FIG. 3. The waveguide configuration 600, as shown, may include an input volume Bragg grating (VBG) 601 (“input grating” or “IG”, “inbound grating”, or “in-coupling grating”), a first middle volume Bragg grating (VBG) 602 (“first middle grating” or “MG1”), a second middle volume Bragg grating (VBG) 603 (“second middle grating” or “MG2”), and an output volume Bragg grating (VBG) 604 (“output grating” or “OG”, “outbound grating”, or “out-coupling grating”). It should be appreciated that, as used herein and in some instances, the terms “grating” and “gratings” may be used interchangeably, in that “grating” may include an arrangement of a plurality of gratings or grating structures.

In some examples, a projector 605 of the display system may transmit display light (indicated by an arrow) to the arrangement of volume Bragg gratings (VBGs) 601-604, starting with the input volume Bragg grating (VBG) 601 (which receives the display light from the projector), then through the first middle volume Bragg grating (VBG) 602 and the second middle volume Bragg grating (VBG) 603, and then to the output volume Bragg grating (VBG) 604 which directs the display light to an eyebox or a user's eye 606.

As discussed above, the waveguide configuration 600 may include any number of volume Bragg gratings (VBGs) that may be exposed into a “see-through” photopolymer material, such as glass or plastic. In some examples and as discussed above, one or more of the arrangement of volume Bragg gratings (VBGs) 601-604 may be patterned (e.g., using sinusoidal patterning) into and/or on a surface of the photopolymer material. In this way, the waveguide configuration 600 may be relatively transparent so that a user may see through to the other side. At the same time, the waveguide configuration 600, with its various arrangements of volume Bragg gratings (VBGs) 601-604 may (among other things) receive the propagated display light from the projector and exit the propagated display light in front of a user's eyes for viewing. In this way any number of augmented reality (AR) and/or mixed reality (MR) environments may be provided to and experienced by the user. In addition, in some examples, the arrangement of volume Bragg gratings (VBGs) 601-604 may be implemented to “expand” (i.e., horizontally and/or vertically) a region in space to be viewed so that a user may view a displayed image regardless of where a pupil of a user's eye may be. As such, in some examples, by expanding this viewing region, the arrangement of volume Bragg gratings (VBGs) 601-604 may ensure that a user may move their eye in various directions and still view the displayed image.

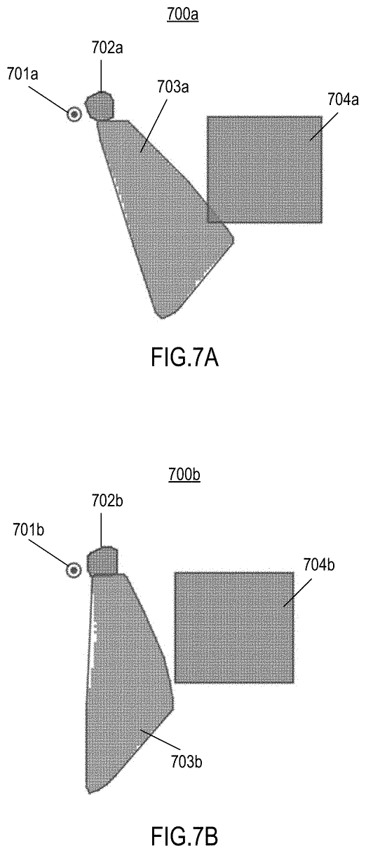

FIGS. 7A-7B illustrate diagrams of waveguide configurations 700a-700b including an arrangement of volume Bragg gratings (VBGs), according to examples. For example, waveguide configuration 700a may illustrate one arrangement of volume Bragg gratings (VBGs) 701a-704a and waveguide configuration 700b may illustrate another arrangement of volume Bragg gratings (VBGs) 701b-704b. It should be appreciated that these waveguide configurations 700a-700b, or other configurations, may be included in a waveguide-based display system, as described herein.

In some examples, as discussed further below, the arrangement of volume Bragg gratings (VBGs) 701a-704a may be combined (i.e., “stacked” or “tiled”) with the arrangement of volume Bragg gratings (VBGs) 701b-704b. In particular, the arrangement of volume Bragg gratings (VBGs) 701a-704a (i.e., directed to a left field of view (FOV)) and the arrangement of volume Bragg gratings (VBGs) 701b-704b (i.e., directed to a right field of view (FOV)) may be implemented (i.e., “tiled”) to cooperatively expand a viewing eyebox and support of a larger field of view (FOV).

In some examples, the arrangement of volume Bragg gratings (VBGs) 701a-704a may include an input volume Bragg grating (VBG) 701a, a first middle volume Bragg grating (VBG) 702a, a second middle volume Bragg grating (VBG) 703a, and an output volume Bragg grating (VBG) 704a. So, in some examples, a projector (not shown) may propagate display light to the input volume Bragg grating (VBG) 701a, through the first middle volume Bragg grating (VBG) 702a and the second middle volume Bragg grating (VBG) 703a, and for exiting through the output volume Bragg grating (VBG) 704a. More specifically, in some examples, a first expansion of a field of view (FOV) (in a first dimension) may be accomplished via the first middle volume Bragg grating (VBG) 702a and the second middle volume Bragg grating (VBG) 703a, while a second expansion of the field of view (FOV) (in a second dimension) may be accomplished via the output volume Bragg grating (VBG) 704a. Indeed, in some examples, this arrangement may enable a −a° to +b° span (e.g., −30° to +5° span) for a first dimension (e.g., horizontal) of a field of view (FOV) and −c° to +d° span (e.g., −20° to +20° span) for a second dimension (e.g., vertical) of a field of view (FOV), where a, b, c, and d may be any number.

Also, as shown in FIG. 7B, in some examples, a projector (not shown) may propagate display light to input volume Bragg grating (VBG) 701b, a first middle volume Bragg grating (VBG) 702b and a second middle volume Bragg grating (VBG) 703b and output volume Bragg gratings (VBG) 704b. Again, in some examples, the projector may propagate display light to the input volume Bragg grating (VBG) 701b, through the first middle volume Bragg grating (VBG) 702b and the second middle volume Bragg grating (VBG) 703b and for exiting through the output volume Bragg grating (VBG) 704b. In particular, in some examples, a first expansion of a field of view (FOV) (in a first dimension) may be accomplished via the first middle volume Bragg grating (VBG) 702b and the second middle volume Bragg grating (VBG) 703b, while a second expansion of the field of view (FOV) (in a second dimension) may be accomplished via the output volume Bragg grating (VBG) 704b. So, in some examples, this arrangement may enable a −a° to +b° span for a first dimension (e.g., horizontal) of a field of view (FOV), and −c° to +d° expansion span for a second dimension (e.g., vertical) of a field of view (FOV), where a, b, c, and d may be any number, similar to what is described above.

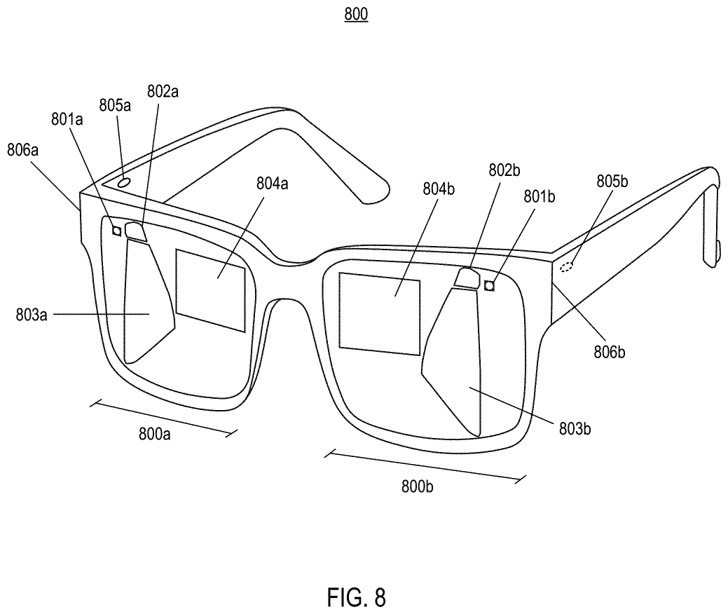

FIG. 8 illustrates a diagram of a back-mounted arrangement for a display system 800 in a shape of eyeglasses, according to an example. In some examples, the display system 800 may include a right waveguide configuration 800a and a left waveguide configuration 800b. Each of the right waveguide configuration 800a and the left waveguide configuration 800b shown here may be similar to the waveguide configuration 600 of FIG. 6. For example, each of the waveguide configurations, as shown in FIG. 8, may use similar types of volume Bragg gratings (VBGs) arrangements to those shown in FIG. 6. For instance, the right waveguide configuration 800a may include an input volume Bragg grating (VBG) 801a, a first middle volume Bragg grating (VBG) 802a, a second middle volume Bragg grating (VBG) 803a, and an output volume Bragg grating (VBG) 804a, and the left waveguide configuration 800b may include an input volume Bragg grating (VBG) 801b, a first middle volume Bragg grating (VBG) 802b, a second middle volume Bragg grating (VBG) 803b, and an output volume Bragg grating (VBG) 804b.

With regard to the right waveguide configuration 800a, in some examples, a right projector 805a may be mounted at an interior side of a right temple arm 806a of the display system 800. In some examples, the right projector 805a may propagate light to and/or through the input volume Bragg grating (VBG) 801a to the first middle volume Bragg grating (VBG) 802a and the second middle volume Bragg grating (VBG) 803a and then to the output volume Bragg grating (VBG) 804a.

With regard to the left waveguide configuration 800b, in some examples, a left projector 805b may be mounted at an interior side of a left temple arm 806b of the display system 800. In some examples, the left projector 805b may propagate light to and/or through the input volume Bragg grating (VBG) 801b to the first middle volume Bragg grating (VBG) 802b and the second middle volume Bragg grating (VBG) 803b and then to the output volume Bragg grating (VBG) 804b.

Accordingly, in some examples, the right waveguide configuration 800a and the left waveguide configuration 800b may present a first display image and a second display image, respectively, to be viewed by a user's respective eye, when wearing the eyewear, to generate a simultaneous, “binocular” viewing. That is, in some examples, the first image projected by the right projector 805a and the second image projected by the left projector 805b may be uniformly and symmetrically “merged” to create a binocular visual effect for a user. It may be appreciated that such an arrangement may provide various benefits to a user.

It should be appreciated that, in some examples, only light that may travel to, through and out of one or more waveguides of a display system may be utilized for viewing by a user (i.e., used light or “display light”). So, in an example where a waveguide may include a first arrangement of volume Bragg gratings (VBGs) and a second arrangement of volume Bragg gratings (VBGs), light that may travel through (i.e., be diffracted by) the first arrangement of volume Bragg gratings (VBGs) but may not travel through (i.e., be diffracted by) the second arrangement of volume Bragg gratings (VBGs) may be unused. Put another way, in some examples, light that may travel through the first arrangement of volume Bragg gratings (VBGs) and the second arrangement of volume Bragg gratings (VBGs) may be required to meet the Bragg conditions for the first arrangement of volume Bragg gratings (VBGs) and the second arrangement of volume Bragg gratings (VBGs), and light that may not meet the Bragg conditions for one or more of the first arrangement of volume Bragg gratings (VBGs) and the second arrangement of volume Bragg gratings (VBGs) may remain unused.

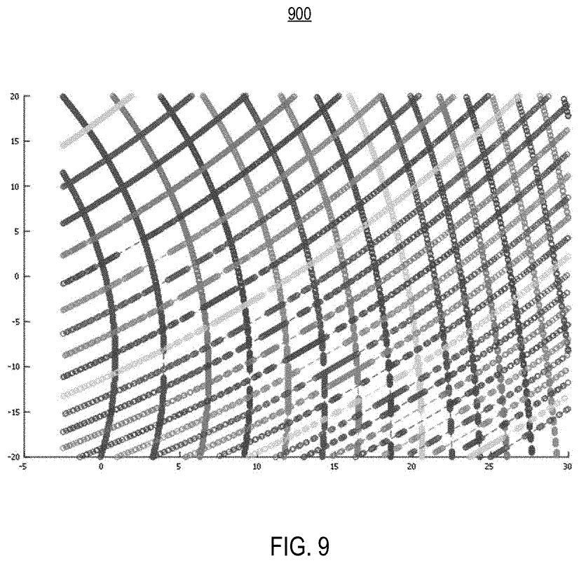

FIG. 9 illustrates a representation 900 of various diffractions associated with an arrangement of gratings for one fixed wavelength, according to an example. In this example, the unit associated x-axis and the unit associated with the y-axis may be degrees. Also, in this example, the first vertical lines may correspond to a first arrangement of gratings (e.g., an in-coupling grating) and the horizontal lines may correspond to a second arrangement of gratings (e.g., a middle grating). In this example, the first arrangement of gratings and the second arrangement of gratings may be included in a waveguide and may employ differing gratings structures.

In this example, light that may meet a Bragg condition (i.e., resonances) for both the first arrangement of gratings and the second arrangement of gratings may be represented by an intersection of a vertical line and a horizontal line. In some instances, this may represent light that may be “used”, wherein the used light may correspond to one or more portions (e.g., dots) of a display being illuminated.

Furthermore, in this example, light that may be represented on a line in between two intersections may not travel through and out of the waveguide (i.e., “unused” light). In addition, in this example, light that may be represented as not on a line (i.e., in between vertical lines and horizontal lines) may not travel through and out of the waveguide (i.e., “unused” light) as well. In some instances, this may correspond to light that may be “unused”, wherein the unused light may manifest as one or more dark areas in between portions (e.g., dots) of a display that may be illuminated. It may be appreciated that, in some instances, a majority of source light for a particular pixel may be wasted.

In some examples, light that may meet a Bragg condition (i.e., resonances) for both a first arrangement of gratings and a second arrangement of gratings may be said to have met a “multiple filtering” condition associated with the first arrangement of gratings and the second arrangement of gratings. Accordingly, such a “multiple filtering” condition may be associated with any plurality of grating arrangements as described herein. Furthermore, in an instance where a projector (e.g., a light-emitting diode (LED) projector) may provide a broadband light source, each wavelength associated with the broadband light source may have used and unused light in a similar manner.

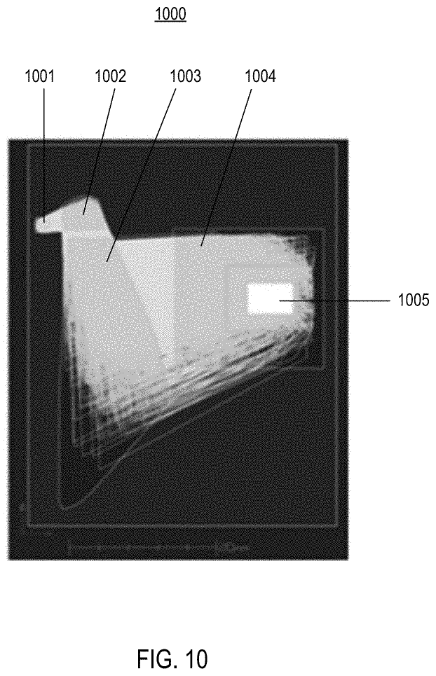

FIG. 10 illustrates a diagram depicting light traveling through a waveguide configuration 1000, according to an example. As discussed above with regard to FIG. 9, in some examples where one fixed wavelength may be implemented, a “multiple filtering” condition may lead to only portions light projected by a projector to be propagated through and out of a waveguide. In such instances, implementation of a broadband light source, projecting a broad spectrum of source wavelengths, may enable an entirety of a field of view (FOV) to be “filled” (i.e., covered) to provide a uniformly bright display.

So, unlike in FIG. 6, where a single light wave is indicated by an arrow, FIG. 10 illustrates a full spectrum of propagated light beams and sample points associated with an entire supported (i.e., angular) field of view (FOV). As discussed further below, in some examples, the waveguide configuration 1000 may include similar types of volume Bragg grating (VBG) arrangements to those shown in FIG. 6.

In this example, a plurality of gratings 1001-1004 of the waveguide configuration 1000 may include input volume Bragg grating (VBG) 1001, a first middle volume Bragg grating (VBG) 1002, a second middle volume Bragg grating (VBG) 1003 and an output volume Bragg grating (VBG) 1004.

In this example, light may be emitted from a projector (not shown) towards the input volume Bragg grating (VBG) 1001. The input volume Bragg grating (VBG) 1001 may direct the light towards the first middle volume Bragg grating (VBG) 1002 and the second middle volume Bragg grating (VBG) 1003, and then towards the output volume Bragg grating (VBG) 1004. Also, in this example, eyebox 1005 may represent an amount and a path (i.e., a display sensing path) of light that may be transmitted for viewing by a user (i.e., used).

In some examples and as discussed further below, display systems having directed wavelength emission components as described may selectively project (only) portions of a wavelength spectrum that may be associated with and/or necessary for an image to be displayed. More particularly, in some examples, the systems and methods may implement directed wavelength emission components to implement a narrow-band light source that may project a particular wavelength spectrum in accordance with a “multiple filtering” condition associated with a plurality of gratings, such as the plurality of gratings 1001-1004.

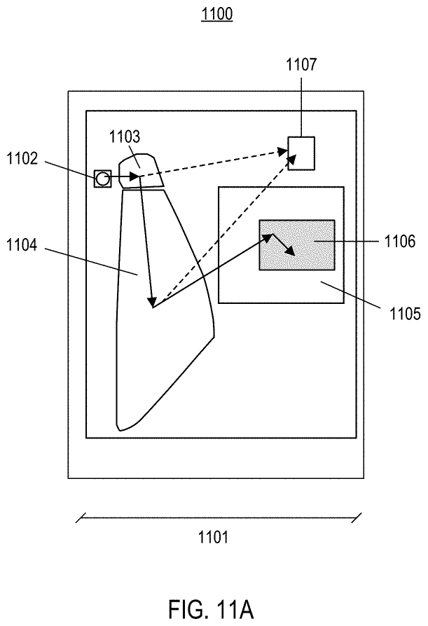

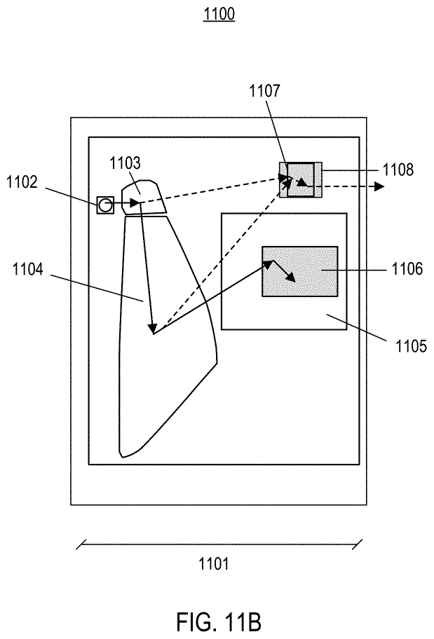

FIGS. 11A-11B illustrates a display system 1100, according to an example. FIGS. 11A and 11B illustrate an eye-side view of the display system 1100 including a waveguide 1101 having a plurality of volume Bragg gratings (VBGs) 1102-1105.

In some examples and as shown in FIGS. 11A and 11B, similar to the previous examples, a projector (not shown) may propagate light to a first input volume Bragg grating (VBG) 1102. The first input volume Bragg grating (VBG) 1102 may then direct the propagated light toward first middle volume Bragg grating (VBG) 1103, and then to second middle volume Bragg grating (VBG) 1104. The propagated light may then travel from the second middle volume Bragg grating (VBG) toward the output volume Bragg grating (VBG) 1105, which may direct the propagated light towards an eyebox 1106. In some examples, the eyebox 1106 may represent a two-dimensional box in front of the user's eye from which a projected image may be viewed. In some examples, the eyebox 1106 may be located 10 millimeters (mm) to 20 millimeters (mm) away from (i.e., in front of) a surface of the waveguide 1101.

In some examples, a disparity sensing port 1107 may be located to receive unused propagated light. In particular, in some examples, the disparity sensing port 1107 may be utilized to receive the unused propagated light so that a disparity sensing detector 1108 may analyze and/or correct image disparities. In some examples, the disparity sensing port 1107 may be a waveguide configuration that may include one or more volume Bragg gratings (VBGs). In some examples, the disparity sensing port 1107 may be designed similarly to the input volume Bragg grating (VBG) 1102 and/or the output volume Bragg grating (VBG) 1105.

In some examples, the disparity sensing detector 1108 may be located behind the disparity sensing port 1107. Also, in some examples, the disparity sensing port 1107 may be located near a waveguide plate surface. So, in one example, a disparity sensing port 1107 may be located near the eyebox 1106. In another example, the disparity sensing port 1107 may be located above the output volume Bragg grating (VBG) 1105.

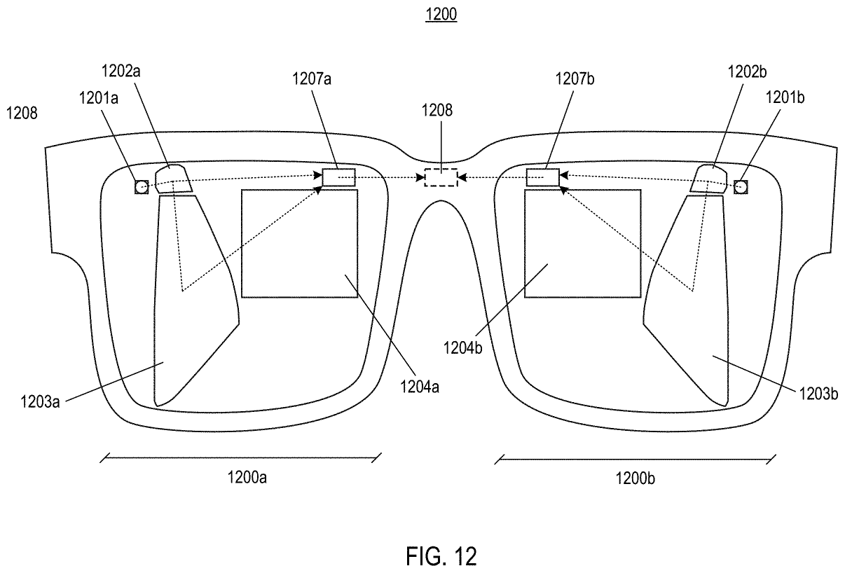

FIG. 12 illustrates a display system 1200, according to another example. In this example, the display system 1200 may be a back-mounted display system in a shape of eyewear (e.g., eyeglasses or other wearable eyewear arrangement).

In some examples, the display system 1200 may include a right waveguide configuration 1200a and a left waveguide configuration 1200b. Each of the right waveguide configuration 1200a and the left waveguide configuration 1200b shown here may be similar to the waveguide configurations 800a, 800b of FIG. 8.

In some examples, the right waveguide configuration 1200a may include an input volume Bragg grating (VBG) 1201a, a first middle volume Bragg grating (VBG) 1202a, a second middle volume Bragg grating (VBG) 1203a, and an output volume Bragg grating (VBG) 1204a. In some examples, the left waveguide configuration 1200b may include an input volume Bragg grating (VBG) 1201b, a first middle volume Bragg grating (VBG) 1202b, a second middle volume Bragg grating (VBG) 1203b, and an output volume Bragg grating (VBG) 1204b.

With regard to the right waveguide configuration 1200a, in some examples, a right projector (not shown) may be mounted at an interior side of a right temple arm of the display system 1200. In some examples, the right projector may propagate light to and/or through the input volume Bragg grating (VBG) 1201a to the first middle volume Bragg grating (VBG) 1202a and the second middle volume Bragg grating (VBG) 1203a and then to the output volume Bragg grating (VBG) 1204a. With regard to the left waveguide configuration 1200b, in some examples, a left projector (not shown) may be mounted at an interior side of a left temple arm of the display system 1200. In some examples, the left projector may propagate light to and/or through the input volume Bragg grating (VBG) 1201b to the first middle volume Bragg grating (VBG) 1202b and the second middle volume Bragg grating (VBG) 1203b and then to the output volume Bragg grating (VBG) 1204b. In some examples, the first waveguide configuration 1200a and the right projector may be included in a first lens assembly of the display system 1200, and the second waveguide configuration 1200b and the left projector may be included in a second lens assembly of the display system 1200.

In some examples, the right projector and the left projector may be “front-mounted” to be located in front (i.e., away from the user's eye and towards a displayed image) of the right waveguide configuration 1200a and the left waveguide configuration 1200b respectively. In some examples, the right projector and the left projector may be “rear-mounted” to be located behind (i.e., closer to the user's eye and away from a displayed image) of the right waveguide configuration 1200a and the left waveguide configuration 1200b respectively.

In some examples, the display system 1200 may include a right disparity sensing port 1205a that may be located near a bridge of a nose. In some examples, the right disparity sensing port 1205a may be configured (e.g., located) to receive unused light that may propagate from the right projector. In some examples, the display system 1200 may include a left disparity sensing port 1205b that may be located near the bridge of a nose. In some examples, the left disparity sensing port 1205b may be configured (e.g., located) to receive unused light that may propagate from the left projector. Moreover, in some examples, the right disparity sensing port 1205a and the left disparity sensing port 1205b may be physically and/or functionally coupled in such a manner as to operate as one element.

In some examples, the right disparity sensing port 1205a and the left disparity sensing port 1205b may direct the unused light from these sources to a disparity sensing detector 1206. So, in some examples, the right disparity sensing port 1205a and the left disparity sensing port 1205b may be configured to receive and provide (e.g., “funnel” or “channel”) the unused light to the disparity sensing detector 1206.

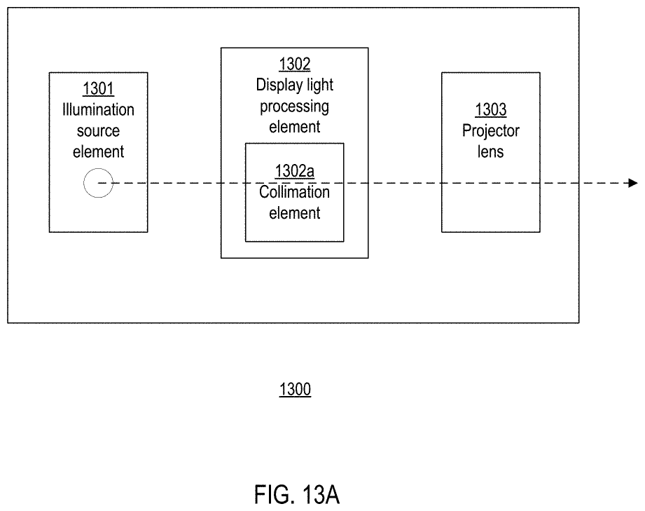

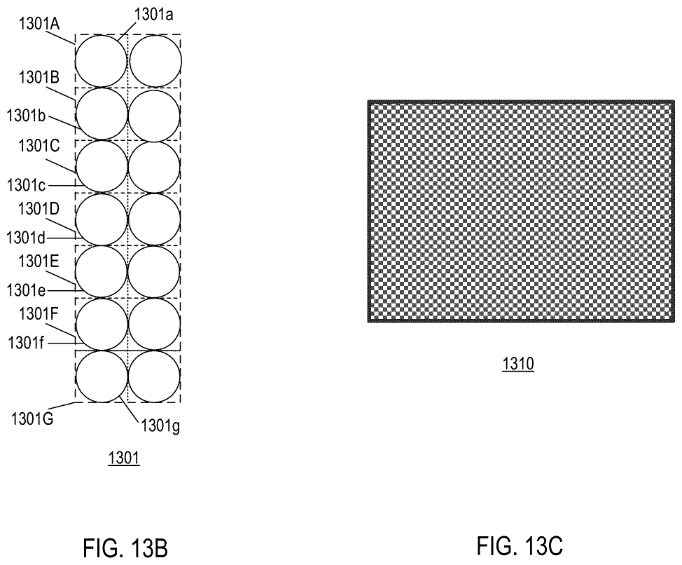

FIGS. 13A-13C illustrate multiple diagrams associated with a projector 1300 that may be included a display system, according to an example. In some examples, the projector 1300 may be similar to the right projector 1201a or the left projector 1201b of FIG. 12.

FIG. 13A illustrates a block diagram of the projector 1300. In some examples, the projector 1300 may include an illumination source component 1301. In some examples, the illumination source component 1301 may generate (i.e., project) display light (indicated by the dotted arrow) to produce a displayed image for viewing by a user. In some examples, the illumination source component 1301 may project the display light for propagation through a waveguide configuration including one or more volume Bragg gratings (VBGs), similar to the right waveguide configuration 1200a and the left waveguide configuration 1200b of FIG. 12.

In some examples, the illumination source component 1301 may be an array of miniaturized (e.g., microscopic) light-emitting diodes (LEDs). In some instances, the miniaturized light-emitting diodes may be referred to as “micro-LEDs,” and the array of micro-LEDs may be referred to as a “micro-LED array”. In some examples, each of the micro-LEDs of the micro-LED array may be associated with an individual pixel element of a display. Accordingly, in some examples, the projector 1300 may enable “pixel-level” projection of display light.

In some examples, the projector 1300 may include a display light processing component 1302. In some examples, the display light processing component 1302 may be utilized to (among other things) analyze and adjust aspects of display light emitted by the illumination source component 1301. In some examples, the display light processing component 1302 may include a collimation component 1302a. In some examples, the collimation component 1302a may (among other things) align aspects (e.g., components) of the projector 1300 to bring display light into focus. More specifically, in some examples, the collimation component 1302a may be implemented to produce one or more (collimated) beams having parallel rays. In addition, in some examples, the collimation component 1302a may “narrow” beams of the display light by causing the beams of the display light to become more aligned in a specific direction and/or by causing a spatial cross section of the beams of the display light to become smaller.

In some examples, the projector 1300 may include a projection lens 1303. In some examples, the projection lens 1303 may be a transmissive optical device including one or more pieces of transparent material(s) arranged along a common axis to focus or disperse a light beam via refraction. In some examples, the projection lens 1303 may be made of glass, while in other examples, the projection lens 1303 may be made of plastic.

FIG. 13B illustrates a front-view of the illumination source component 1301 having one or more micro-LEDs 1301a-1301g. As discussed above, in some examples, the one or more micro-LEDs 1301a-1301g may be arranged as an array. FIG. 13B illustrates an array have two columns and seven rows of the one or more micro-LEDs 1301a-1301g. It may be appreciated that a micro-LED array as described herein may include any number of rows and columns as well.

In some examples, each of one or more pixel areas 1301A-1301G may correspond to the one or more micro-LEDs 1301a-1301g in the illumination source component 1301. As used herein, a “pixel area” may be an area surrounding a micro-LED that may generally correspond to a pixel area for an associated display image. In some examples, upon projection by the illumination source component 1301 and propagation through the projection lens 1303, the display light may generate a pixelated display image 1310, as illustrated in FIG. 13C.

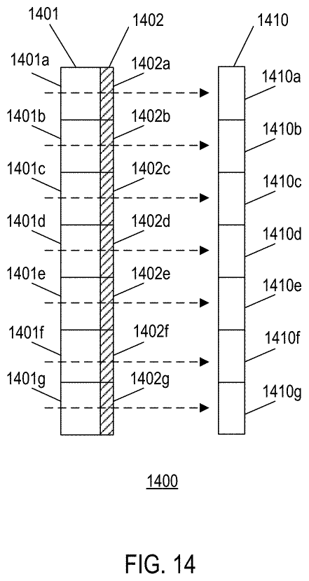

FIG. 14 illustrates a diagram 1400 of an illumination source component 1401 and a directed wavelength emission component 1402, according to an example. In particular, FIG. 14 may illustrate a side-view of the illumination source component 1401 and the directed wavelength emission component 1402. In some examples, the illumination source component 1401 may be similar to the illumination source component 1301 in FIG. 13A.

As will be discussed further below, in some examples, the directed wavelength emission component 1402 may operate as a “filter” (e.g., a spectral filter), and may filter light emitted by the illumination source component 1401 in a directed (i.e., particular) manner and/or according to one or more filtering characteristics to emit light that may be used for display of an image. It may be appreciated that elements and aspects of the directed emission component 1402 may be provided based on aspect(s) of the illumination source component 1401 that may be implemented.

In some examples, the illumination source component 1401 may be a micro-LED array including one or more micro-LEDs 1401a-1401g that may provide a broadband light source for displaying an image. In the example illustrated in FIG. 14, one column and seven rows of the micro-LED array are illustrated from a side-view. In some examples, each of the one or more micro-LEDs 1401a-1401g may correspond to one or more individual pixels 1410a-1410g in an image to be displayed 1410. It may be appreciated that, in various examples, the micro-LED array may include any number of rows and columns of micro-LEDs.

In some examples, the directed wavelength emission component 1402 may be implemented as a Bragg reflector to filter light emitted by the illumination source component 1401. In some examples, a Bragg reflector (or “Bragg mirror”) may be a mirror structure that may include an alternating sequence of layers of two different optical materials with varying refractive indexes, resulting in periodic variation in the effective refractive index in the structure. That is, in some examples, a boundary of each layer of the alternating sequence of layers may cause a partial reflection (i.e., a Fresnel reflection) of an optical wave. For the range of wavelengths that may be reflected, light may be unable to propagate within and through the structure (i.e., the light may be “filtered”).

In some examples, the directed wavelength emission component 1402 may include one or more wavelength direction portions 1402a-1402g. In some examples, each of the wavelength direction portions 1402a-1402g may correspond to the one or more micro-LEDs 1401a-1401g of the illumination source component 1401 (e.g., a micro-LED array). In particular, in some examples, each of the wavelength direction portions 1402a-1402g may operate as a spectral filter and may filter light emitted by the one or more micro-LEDs 1401a-1401g in a directed (i.e., particular) manner to emit light that may be used for display of an image. So, in some examples, the wavelength direction portion 1402a may filter light emitted by the micro-LED 1401a, the wavelength direction portion 1402b may filter light emitted by the micro-LED 1401b, and so on.

In some examples, the directed wavelength emission component 1402 may be partially or fully coupled (e.g., physically) to the illumination source component 1401 (e.g., a micro-LED array), and may be configured to filter the light propagated by the illumination source component 1401. As such, in some examples, the directed wavelength emission component 1402 may be located (i.e., placed) on top of the illumination source component 1401. More specifically, in some examples, the wavelength direction portion 1402a may be located on top of the micro-LED 1401a, the wavelength direction portion 1402b may located on top of the micro-LED 1401b, and so on. In other examples, the directed wavelength emission component 1402 may be located adjacent to (e.g., physically separated from) the illumination source component 1401. Accordingly, in some examples, the wavelength direction portion 1402a may be located adjacent to the micro-LED 1401a, the wavelength direction portion 1402b may located adjacent to the micro-LED 1401b, and so on.

Accordingly, in some examples, each of the wavelength direction portions 1402a-1402g may enable the illumination source component 1401 to provide particular and/or adjustable wavelength emission characteristics (i.e., “source-tuning”). In some examples, a directed wavelength emission component 1402 may enable “pixel-level” control (i.e., selectivity) of emission of wavelength bands. As a result, in some examples and as discussed further below, the directed emission component 1402 may reduce or eliminate projection of unused (i.e., wasted) light that may be energy inefficient and/or may reduce image quality.

In some examples, each of the wavelength direction portions 1402a-1402g may be configured to provide filtering characteristics that may filter out (i.e., block) light of a particular wavelength spectrum that may be or may likely be unused for each associated pixel in a display. In addition, each of the wavelength direction portions 1402a-1402g may also be configured to provide to propagate (i.e., pass through) light of a particular wavelength spectrum that may be or may likely to be used for each pixel associated with a display.

In some examples, the directed wavelength emission component 1402 may be configured to provide varying wavelength emission characteristics based on a location (on the illumination source component 1401). That is, in some examples, since each of the one or more wavelength direction portions 1402a-1402g may each provide particular (i.e., same or unique) filtering characteristics that may enable each of the one or more micro-LEDs 1401a-1401g to filter for a particular wavelength spectrum for each associated pixel in a display, the directed wavelength emission component 1402 may be said to enable implementation of a “position-dependent” wavelength spectrum.

In some examples, a particular band of wavelengths that may be propagated via a filtering condition by (i.e., passed through) each of the wavelength direction portions 1402a-1402g may correspond to a “multiple filtering” condition for an associated waveguide configuration (as discussed above). As a result, in some examples, the directed wavelength emission component 1402 may be able to propagate (i.e., pass through) light in accordance with one or more Bragg conditions for a plurality of gratings (or grating sets) that may be associated with in a particular pixel to be displayed.

Furthermore, in some examples, each of the wavelength direction portions 1402a-1402g may enable implementation of particular angular characteristics for each pixel (i.e., “angle dependent filtering”). So, in some examples, for an arrangement of one or more volume Bragg gratings (VBGs) having a thickness of approximately fifty micrometers (50 μm), the “multiple filtering” condition associated with a volume Bragg grating (VBG) arrangement in a waveguide configuration may result in an angular scale of approximately one degree (1°). Furthermore, in some examples, where approximately twenty (20) pixels having a pixel pitch of four micrometers (4 μm) may exhibit the “multiple filtering” condition of approximately one degree (1°), this may result in a spatial resolution requirement of approximately (i.e., 4 μm per pixel*20 pixels/degree) eighty micrometers (80 μm).

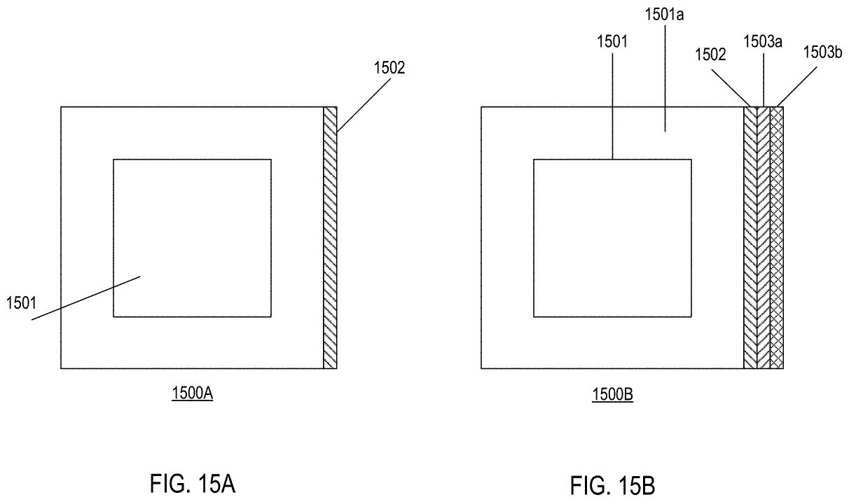

FIGS. 15A-15B illustrate multiple diagrams of an illumination source component 1500A-1500B, according to examples. In particular, FIG. 15A may illustrate a side-view of a first example of the illumination source component 1500A, and FIG. 15B may illustrate a side-view of a second example of the illumination source component 1500B. In some examples, the illumination source component 1500A or 1500B may be similar to the illumination source component 1301 in FIG. 13A.

In some examples, a spectrum of the display light emitted by the illumination source component 1500A or 1500B may be based on aspects (e.g., a shape) of the illumination source component 1500A or 1500B. For example, in some examples, a wavelength of emitted display light may be similar to a size of the illumination source component 1500A or 1500B. However, unlike the example(s) illustrated in FIG. 14 where the directed wavelength emission component 1402 may operate as a “filter” (e.g., a spectral filter), in the examples illustrated in the FIGS. 15A-15B (and as described further below), a directed wavelength emission component 1503 included in the illumination source component 1500A or 1500B may implement one or more emission characteristics that may enable “selective emission” of display light that may be used for display of an image.

In some examples, the illumination source component 1500A may be a micro-LED included in a micro-LED array that may provide a broadband light source for displaying an image. In some examples, each micro-LED of the illumination source component 1500A or 1500B may be individually addressable and individually luminous (i.e., “pixel-scale control”) in correspondence with one or more individual pixels in an image to be displayed.

As illustrated in FIGS. 15A-15B, in some examples, the illumination source component 1500A or 1500B may include a “p-n junction” contact diode 1501 (or “contact diode 1501”) that may be formed by positive-type gallium nitride (GaN) material and negative-type gallium nitride (GaN) material, wherein both materials may be in close contact. In some examples, upon application of a positive voltage on the positive-type gallium nitride (GaN) and a negative voltage on the negative-type gallium nitride (GaN) side, the contact diode 1501 may enable a radiative recombination to produce light emission. In some examples, the contact diode 1501 may be housed within a housing component 1501a.

Also, in some examples, the illumination source component 1500A may include a micro-LED cavity 1502 (also “micro-cavity 1502”) that may (among other things) increase light extraction efficiency. In particular, in some examples, the micro-cavity 1502 may be a patterning that may be layered on top of the surface of the contact diode 1501 to enable light projection.

FIG. 15B illustrates an example of the illumination source component 1500B including the contact diode 1501, the micro-cavity 1502, and a directed wavelength emission component 1503. In some examples, the directed wavelength emission component 1503 may be a cavity structure that may be etched or patterned on top of the micro-cavity 1502. So, in effect, in some examples, the cavity structure for controlling an emission spectrum may be same as the micro-cavity 1502, such that wavelength selectivity may be achieved by modifying the micro-cavity 1502. In other examples, the directed wavelength emission component 1503 may be a cavity structure that may be etched or patterned directly on a surface of the contact diode 1501. In some examples and as discussed further below, resonance characteristics of the directed wavelength emission component 1503 may be provided to operate like a Bragg mirror (or Bragg reflector) to enable selective emission of display light from the illumination source component 1500B (i.e., “spectrally selective”).

In some examples, selective emission enabled by the directed wavelength emission component 1503 may be implemented via use of a multilayer cavity “stack,” wherein the multilayer cavity stack may include a plurality of cavity layers. In some examples, the multilayer cavity stack may include a first cavity layer 1503a and a second cavity layer 1503b. It may be appreciated that, in some examples, the multilayer cavity stack may include any number of layers.

In some examples, the first cavity layer 1503a and the second cavity layer 1503b of the directed wavelength emission component 1503 may be comprised of a first optical material and a second optical material respectively. In particular, in some examples, the first optical material may have a first refractive index and the second optical material may have a second (i.e., different) refractive index. In some examples, this may result in a periodic variation of an effective refractive index for the directed wavelength emission component 1503. As discussed above, in some examples, the periodic variation of the effective refractive index may cause a particular range of wavelengths may be reflected, and a portion of the display may be unable to propagate within and through the illumination source component 1500B.

Accordingly, in some examples, to selectively emit display light, each of the first cavity layer 1503a and the second cavity layer 1503b of the directed wavelength emission component 1503 may be implemented to have particular (i.e., varying) wavelength emission characteristics. In some examples, for each pixel in an associated display, the selective emission component 1503 may be adjusted to selectively emit a particular wavelength spectrum that may be used and to selectively not emit portions of the wavelength spectrum that may be unused. Indeed, in some examples, it may be appreciated that aspects of the directed wavelength emission component 1503 and/or the illumination source component 15006 may be configured to enable a maximizing of projection of light that may be used, while minimizing projection of light that may be unused. In some examples, optimizing of aspects of the illumination source component 1500 may be implemented according to Maxwell's equations.

Moreover, in some examples, the directed wavelength emission component 1503 may enable “pixel-level” (or “pixel-scale”) control of emission of wavelength bands. In particular, in some examples, each of the first cavity layer 1503a and the second cavity layer 1503b may be configured to provide selective emission characteristics that may be configured to selectively emit (only) light of a particular wavelength spectrum that may be or may likely be used for each pixel associated with a display.

Also, in some examples, by varying the properties for each directed wavelength emission component 1503 from one micro-LED to another, an associated micro-LED array may exhibit a “position-dependent” wavelength spectrum(s) for each pixel wherein a particular (e.g., narrow) band of wavelengths may propagate (i.e., pass through). In some instances, this may constitute “source tuning” of the illumination source element 1500 and/or an associated micro-LED array as a function of location in a display.

In some examples, the directed wavelength emission component 1503 may implement “angle dependent filtering”, wherein a wavelength spectrum with particular angular characteristics for each pixel may be provided. In some examples, a particular band of wavelengths that may be propagated by (i.e., passed through) the directed wavelength emission component 1503 may correspond to a “multiple filtering” condition for an associated waveguide configuration. As discussed above, in some examples, the directed wavelength emission component 1503 may be configured to propagate (i.e., pass through) light that may meet one or more Bragg conditions for a plurality of gratings (or grating sets) that may be associated with in a particular pixel to be displayed.

In some examples, wavelength selectivity may be implemented via “current tuning.” As used herein, “current tuning” may include utilizing varying electrical currents to provide an emission spectrum of a light-emitting diode (LED). That is, in some examples, it may be feasible to implement a source spectrum via implementation of a tunable current.

As described above, in some instances, since a significant amount of light typically projected by a projector in a display system may be unused, the systems and methods described herein may enable reduced energy consumption (i.e., increase energy efficiency) by display devices. Moreover, in some examples, by projecting (only) portions of a wavelength spectrum that may be associated with (e.g., necessary for) projection of an image to be displayed, the systems and methods described herein may also enhance image quality (e.g., via reduction of artifacts, haze, crosstalk, etc.) as well.

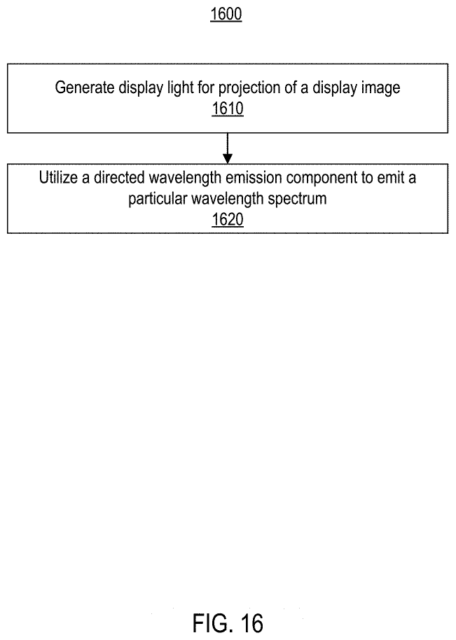

FIG. 16 illustrates a method for selective emission of wavelength bands in a display system utilizing a directed wavelength emission component, according to an example. The method 1600 is provided by way of example, as there may be a variety of ways to carry out the method described herein. Each block shown in FIG. 16 may further represent one or more processes, methods, or subroutines, and one or more of the blocks may include machine-readable instructions stored on a non-transitory computer-readable medium and executed by a processor or other type of processing circuit to perform one or more operations described herein.

Reference is now made with respect to FIG. 16. At 1610, a projector may generate display light for projection of a display image. In some examples, the display light may be generated by one or more micro-LEDs in a micro-LED array included in the projector. In some examples, the micro-LED array may be a broadband light source.

At 1620, a directed wavelength emission component may be utilized to emit a particular (i.e., select) wavelength spectrum that may be associated with a displayed image for viewing by a user. In some examples, the directed wavelength emission component may be implemented to filter to block a portion of a wavelength spectrum that is unused and filter to propagate a portion of the wavelength spectrum that is used. In some examples, the directed wavelength emission component may be implemented to selectively not emit a portion of a wavelength spectrum that is unused and to selectively emit a portion of the wavelength spectrum that is used.

In the following description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A display system, comprising:
a wearable eyewear arrangement having a lens assembly, the lens assembly comprising:
a projector to project display light associated with an image, the projector including:
an illumination source component to generate the display light; and
a directed wavelength emission component coupled to the illumination source component to filter the display light according to one or more filtering characteristics; and
a waveguide for propagating the display light to enable viewing of the image by a user.

2. The system of claim 1, wherein the directed wavelength emission component is implemented as a Bragg reflector to filter the display light.

3. The system of claim 1, wherein the one or more filtering characteristics include filtering to block the display light of a particular wavelength spectrum that is unused and filtering to propagate the display light of a particular wavelength spectrum that is used.

4. The system of claim 1, wherein the illumination source component is an array of micro-light emitting diodes (LEDs).

5. The system of claim 4, wherein the directed wavelength emission component includes one or more wavelength direction portions.

6. The system of claim 5, where a first micro-light emitting diode (LED) of the array of micro-light emitting diodes (LEDs) is coupled to a first wavelength direction portion of the one or more wavelength direction portions and a second micro-light emitting diode (LED) of the array of micro-light emitting diodes (LEDs) is coupled to a second wavelength direction portion of the one or more wavelength direction portions.

7. The system of claim 6, wherein the first wavelength direction portion implements a first filtering characteristic and the second wavelength direction is portion implements a second filtering characteristic.

8. The system of claim 7, wherein the first filtering characteristic and the second filtering characteristic are based on a multiple filtering condition of the waveguide.

9. The system of claim 6, wherein the first wavelength direction portion is located on top of the first micro-light emitting diode (LED) and the second wavelength direction portion is located on top of the second micro-light emitting diode (LED).

10. An apparatus, comprising:
a projector to project display light associated with an image, the projector including:
an illumination source component to generate the display light; and
a directed wavelength emission component coupled to the illumination source component to selectively emit the display light according to one or more emission characteristics; and
a waveguide for propagating the display light to enable viewing of the image by a user.

11. The apparatus of claim 10, wherein the one or more emission is characteristics include emitting the display light of a particular wavelength spectrum that is used and not emitting display light of a particular wavelength spectrum that is unused.

12. The apparatus of claim 10, wherein the illumination source component comprises a micro-light emitting diode (LEDs) having a micro-cavity.

13. The apparatus of claim 12, wherein the directed wavelength emission component is implemented as a multilayer cavity stack.

14. The apparatus of claim 13, wherein the multilayer cavity stack is etched or patterned on top of the micro-cavity.

15. The apparatus of claim 13, wherein the multilayer cavity stack comprises a plurality of cavity layers including a first cavity layer and a second cavity layer.

16. The apparatus of claim 15, wherein the first cavity layer is made of a first optical material and the second cavity layer is made of a second optical material.

17. The apparatus of claim 10, wherein the one or more emission characteristics are based on a multiple filtering condition of the waveguide.

18. A method for selective emission of wavelength bands in a display system, comprising:
generating display light for projection of a display image; and
implementing a directed wavelength emission component to emit a particular wavelength spectrum associated with display of the display image.

19. The method of claim 18, wherein the implementing the directed wavelength emission component includes filtering to block a portion of a wavelength spectrum that is unused and filtering to propagate a portion of the wavelength spectrum that is used.

20. The method of claim 18, wherein the implementing the directed wavelength emission component includes selectively not emitting a portion of a wavelength spectrum that is unused and selectively emitting a portion of the wavelength spectrum that is used.
